(19) United States
(12) Patent Application Publication
(10) Pub. No.: US 2013/0143184 A1
(43) Pub. Date: Jun. 6, 2013

(54) APPARATUS AND METHOD FOR TEACHING A LANGUAGE

(71) Applicant: TEACHING TECH LLC, Evanston, IL (US)

(72) Inventors: Sarah NEIKRUG, Evanston, IL (US); Liat Penso, Skokie, IL (US)

(73) Assignee: TEACHING TECH LLC, Evanston, IL (US)

(21) Appl. No.: 13/692,158

(22) Filed: Dec. 3, 2012

Related U.S. Application Data
(60) Provisional application No. 61/565,802, filed on Dec. 1, 2011.

(51) Int. Cl. G09B 19/00

(52) U.S. Cl. CPC G09B 19/00
USPC 434/169

(57) ABSTRACT

The present disclosure discloses a method and a system of natural language training. The method comprises identifying a word that is to be read by a reader, the word comprising a plurality of letters, determining a visual symbol associated with at least one of the plurality of letters, and manifesting the visual symbol in association with the at least one of the plurality of letters. The visual symbol is associated with a predetermined speech sound. The visual symbol comprises a shape that includes a triangle, a character that includes an IPA symbol, or a fill that includes a color.

### CROSS REFERENCE TO PRIOR APPLICATIONS

This patent application claims prior to and the benefit thereof from U.S. provisional patent application No. 61/565,802, filed Dec. 1, 2011, titled “Shape Up Reading English,” the entirety of which is hereby incorporated herein by reference.

### COPYRIGHT NOTICE

This present application includes material that is subject to copyright protection. The copyright owner does not object to the facsimile reproduction of the application by any person as the application appears in the records of the U.S. Patent and Trademark Office, but otherwise reserves all rights in the copyright.

### FIELD OF THE DISCLOSURE

The present disclosure is directed to an apparatus, a method, a system and a computer program for teaching or learning a language, such as, e.g., English, including faster and easier decoding and reading of words.

### BACKGROUND OF THE DISCLOSURE

Learning to read is a challenging task. Even the most developed countries can have millions of citizens who either have poor reading skills or are completely illiterate. The lack of this vital skill can cause numerous hardships for a person including, but not limited to, the lack of employment. In addition, when an emerging reader does not understand how to correctly sound out a word, it can lead to mispronunciation, the avoidance of reading, humiliation, and can adversely affect comprehension of the text. Therefore, a long felt need exists for an apparatus, a system, a computer program, and/or a method that will allow a person to learn (or teach) to read in an efficient and enjoyable manner.

### SUMMARY OF THE DISCLOSURE

According to an aspect of the instant disclosure, a method of natural language training is disclosed, which comprises: identifying a word that is to be read by a reader, the word comprising a plurality of letters; determining a visual symbol associated with at least one of the plurality of letters; and manifesting the visual symbol in association with the at least one of the plurality of letters, wherein the visual symbol is associated with a predetermined speech sound, and wherein the visual symbol comprises: a shape that includes a triangle; a character that includes an IPA symbol; or a fill that includes a color. The character and/or fill may be formed in the shape. The shape may comprise a boundary that includes a boundary color. The fill may comprise a fill color that is substantially the same as or different from the boundary color.

The visual symbol may be manifested in association with the at least one of the plurality of letters comprises displaying the visual symbol proximate to the at least one of the plurality of letters on a display. The visual symbol may be manifested in association with the at least one of the plurality of letters comprises printing the visual symbol proximate to the at least one of the plurality of letters on a teach medium.

According to another aspect of the disclosure, the method of of natural language training may comprise: identifying a word that is to be read by a reader, the word comprising a plurality of letters; determining a visual symbol associated with at least one of the plurality of letters; and manifesting the visual symbol in association with the least one of the plurality of letters. The visual symbol may be associated with a predetermined speech sound.

The visual symbol may comprise at least one of a shape, a character, and a fill. The visual symbol further may further comprise a grouper that is associated with two or more of the plurality of letters. The visual symbol may be associated with an isolated consonant sound, or with two or more of the plurality of letters, and wherein the visual symbol represents a combination of two or more consonants. The visual symbol may be associated with two or more of the plurality of letters, and wherein the visual symbol represents a combination of two or more vowels.

The predetermined speech sound may be selected from a dipthong sound, a consonant sound, a double consonant grapheme sound, a double consonant sound, a multiple sound consonant grapheme, a silent sound, a vowel sound, and a syllable division markup. The predetermined speech sound may comprise a silent sound. The predetermined speech sound may be derived. from a phonetic alphabet or a phonetic vowel chart.

The grouper may comprise a bracket or a parenthetical to represent a combination of two or more consonants.

According to a further aspect of the disclosure, a system is provide for training a reader to read a natural language. The system comprises a computer that: identifies a word that is to be read by a reader, the word comprising a plurality of letters; determines a visual symbol associated with at least one of the plurality of letters; and displays the visual symbol in association with the at least one of the plurality of letters.

Additional features, advantages, and embodiments of the disclosure may be set forth or apparent from consideration of the following attached detailed description and drawings. Moreover, it is to be understood that both the foregoing summary of the disclosure and the following attached detailed description are exemplary and intended to provide further explanation without limiting the scope of the disclosure as claimed.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings. No attempt is made to show aspects of the disclosure in more detail than may be necessary for a fundamental understanding of the disclosure and the various ways in which it may be practiced.

FIG. 1 shows examples of IPA symbols for English vowels, including examples of English words that may be include the vowels;

FIGS. 2A and 2B show examples of IPA symbols for English vowels and dipthongs, respectively, including examples of English words that may include the vowels and dipthongs;

FIG. 2C shows examples of IPA symbols for consonants, including examples of English words that may include the consonants;

FIG. 2D shows a table comprising three columns, including a column for phonemes, a column for graphemes, and a column for words that may serve as examples for the particular examples of phonemes and graphemes;

FIG. 3A shows an example of a visual symbol according to the principles of the instant disclosure;

FIG. 3B shows a plurality of examples of associations between root vowel sounds and variations of vowel sounds that may be represented by the visual symbols 10, according to the principles of the disclosure;

FIG. 4 shows an example of a visual symbol generation process, according to principles of the disclosure;

FIG. 5 shows an example of a system that is constructed according to the principles of the disclosure;

FIG. 6 shows six examples of words (or names) for which visual symbols may be generated and displayed along with the words (or names);

FIGS. 7-9 show various examples in which English-language letters and words may be represented (or coded) using the visual symbols according to the principles of the disclosure;

FIGS. 10A and 10B show a pair of examples wherein visual symbols have been generated for the words “bin” and “bubble,” respectively;

FIG. 11 shows an example of teaching (or learning) to read (and annunciate) the consonants “b,” “d,” “f,” “g,” and “h,” as well as the words “beauty,” “book,” “dry,” “desk,” “fun,” “frame,” “grape,” “girl,” “hat,” and “help”;

FIG. 12 shows an example of teaching (or learning) to read (and annunciate) the double consonants “bb,” “dd,” “ff,” and “gg,” as well as the words “bubble,” “add,” “giraffe,” and “juggle”;

FIG. 13 shows an example of show a visual symbol that may be generated for a single consonant (e.g., “k”) where the consonant may be, e.g., silent in the spoken word (e.g., “know”);

FIG. 14 shows a plurality of examples of visual symbols that may be generated to represent the multiple sounds that some consonants make, such as “k” and “s” as they are used in the words, e.g., “cake,” “accord,” “chick,” “chemical,” and “city”, or how the letter “s” can make both the /s/ and /z/ sounds;

FIG. 15 shows a plurality of examples of visual symbols that may be generated to represent the letters “ch,” “th,” “th,” and “wh” as they are used in the words “cherry,” “three,” “that,” and “where,” respectively; and

FIG. 16 shows a plurality of examples of implementations of the visual symbol to represent letters in words where the letters are silent (or not sounded) when spoken.

The present disclosure is further described in the detailed description that follows.

### DETAILED DESCRIPTION OF THE DISCLOSURE

The aspects of the present disclosure and the various features and advantageous details thereof are explained more fully with reference to the non-limiting aspects and examples that are described and/or illustrated in the accompanying drawings and detailed in the following description. It should be noted that the features illustrated in the drawings are not necessarily drawn to scale, and features of one aspect may be employed with other aspects as the skilled artisan would recognize, even if not explicitly stated herein. Descriptions of well-known components and processing techniques may be omitted so as to not unnecessarily obscure the aspects of the present disclosure. The examples used herein are intended merely to facilitate an understanding of ways in which the present disclosure may be practiced and to further enable those of skill in the art to practice the aspects of the present disclosure. Accordingly, the examples and aspects herein should not be construed as limiting the scope of the present disclosure, which is defined solely by the appended claims and applicable law. Moreover, it is noted that like reference numerals represent similar parts throughout the several views of the drawings.

The International Phonetic Alphabet (IPA) is an alphabetic system comprising phonetic notation, which is primarily based on the Latin alphabet. The IPA generally represents only those qualities of speech that tend to be distinctive in spoken language—e.g., phonemes, intonation, and the separation of words and syllables. The IP may also represent additional qualities of speech, such as, for example, a lisp, teeth gnashing, and the like. As of the writing of this patent disclosure, the IPA provided a symbol for each distinctive sound, including, e.g., one-hundred-and-seven (107) symbols that represent consonants and vowels, thirty-one (31) that represent diacritics which may be used to modify the consonants and vowels, and nineteen (19) symbols that represent sound qualities such as, for example, intonation, tone, length, and stress.

For example, the IPA includes the following symbols for English consonants: p (e.g., pen); b (e.g., but); t (e.g., two); d (e.g., do, odd); [symbol] (e.g., chair, nature, teach); [symbol] (e.g., gin, joy) k (e.g., skin, unique, thick); g (e.g., go); f (e.g., fool, enough, leaf); v (e.g., voice, of); θ (e.g., thing, teeth); δ (e.g., breathe, father); s (e.g., see, city, pass); z (e.g., zoo, rose); ∫ (e.g., she, sure, emotion, leash); 3 (e.g., pleasure, beige, equation, seizure); x (e.g., loch); h (e.g., ham); m (e.g., man); n (e.g., no, tin); η (e.g., ring, sing, drink); l (e.g., left, bell); r (e.g., run, very); w (e.g., we, queen); j (e.g., yes); and hw (e.g., what).

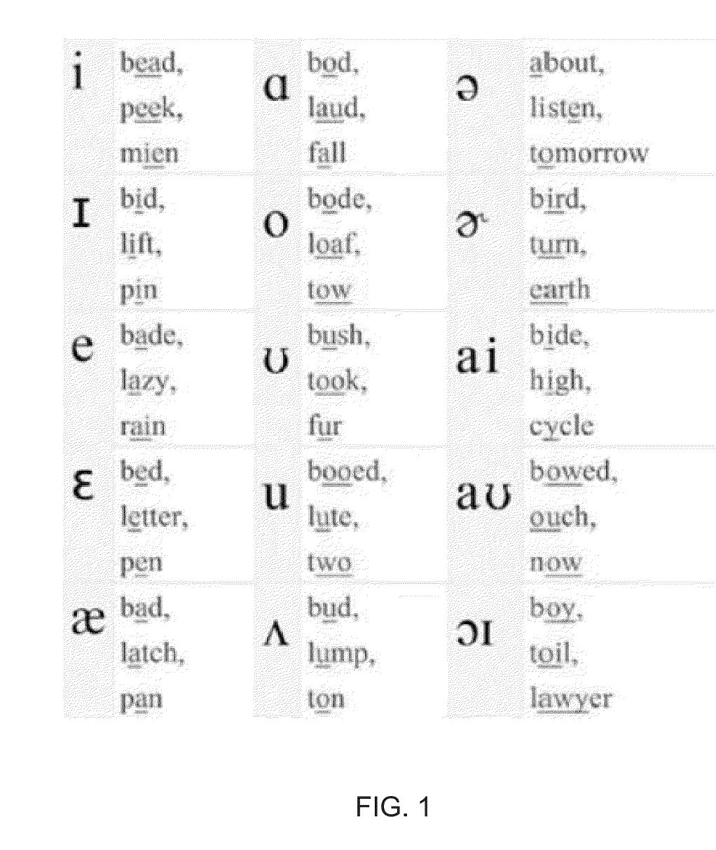

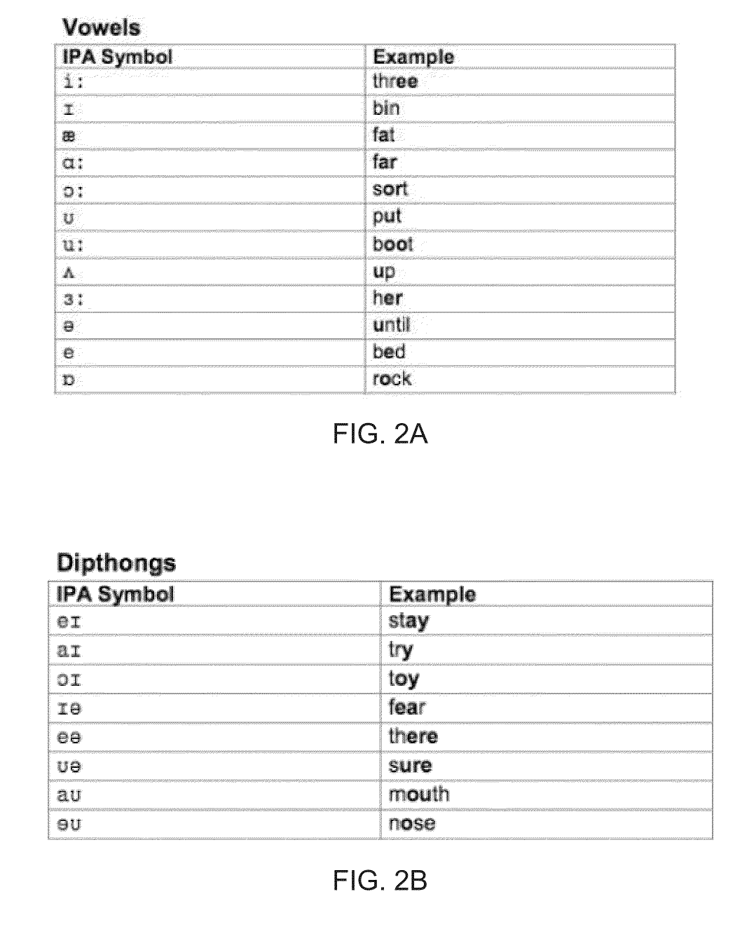

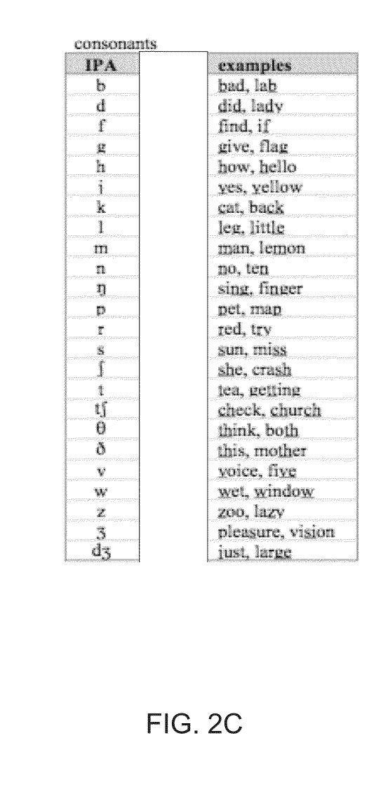

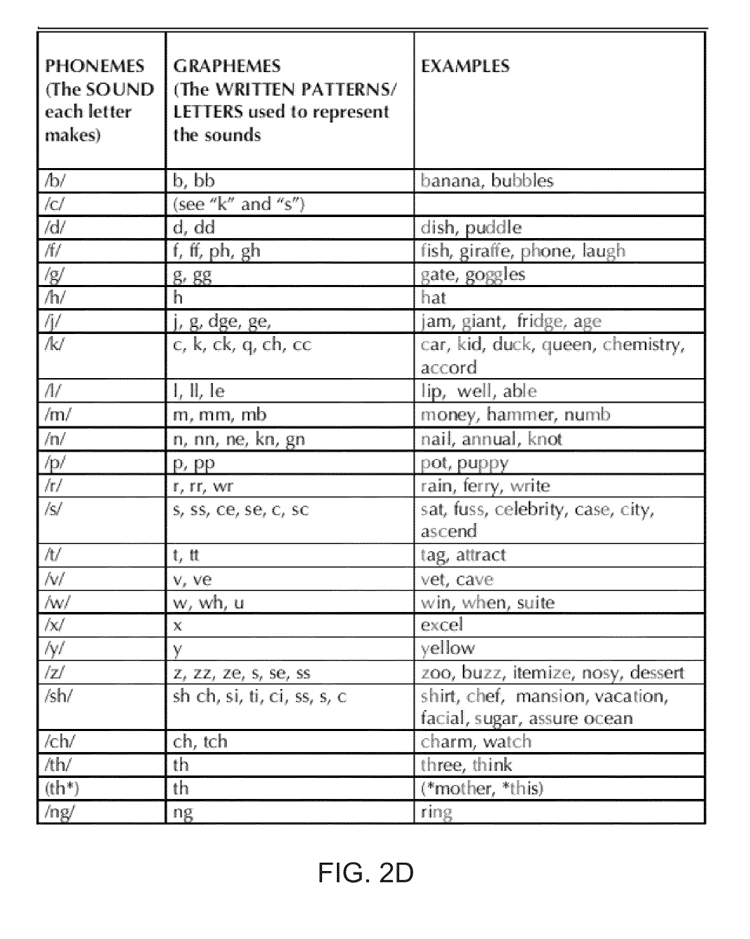

FIG. 1 shows examples of IPA symbols for English vowels, including examples of English words that may be include the vowels. FIGS. 2A and 2B show examples of IPA symbols for English vowels and dipthongs, respectively, including examples of English words that may include the vowels and dipthongs.

FIG. 2C shows examples of IPA symbols for consonants, including examples of English words that may include the consonants.

FIG. 2D shows a table comprising three columns, including a column for phonemes, a column for graphemes, and a column for words that may serve as examples for the particular examples of phonemes and graphemes.

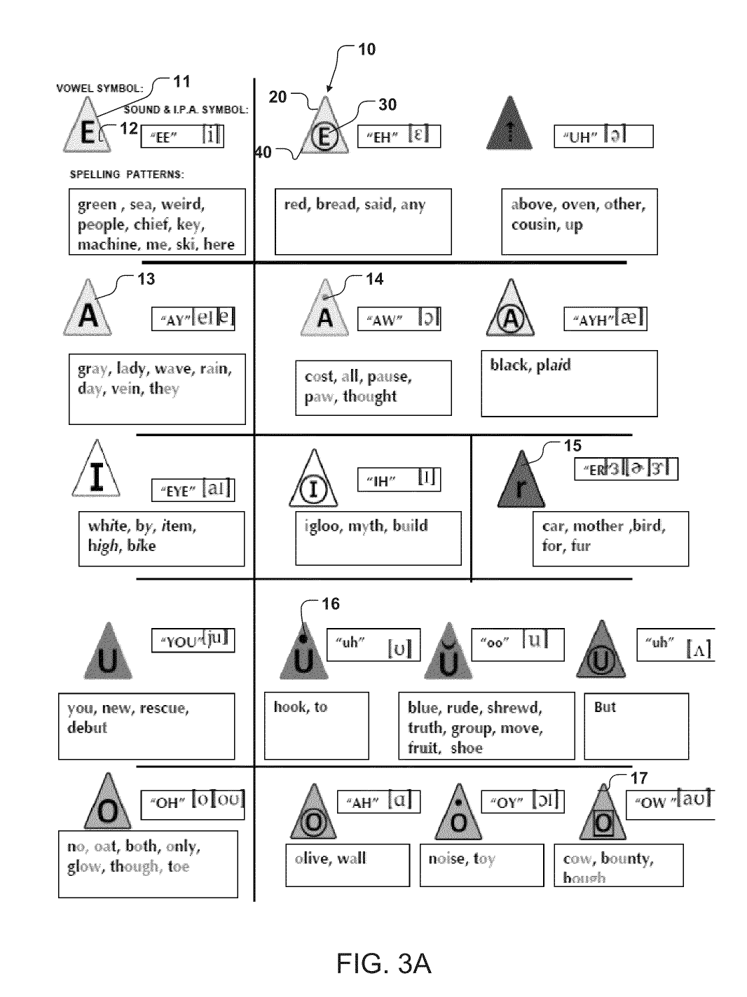

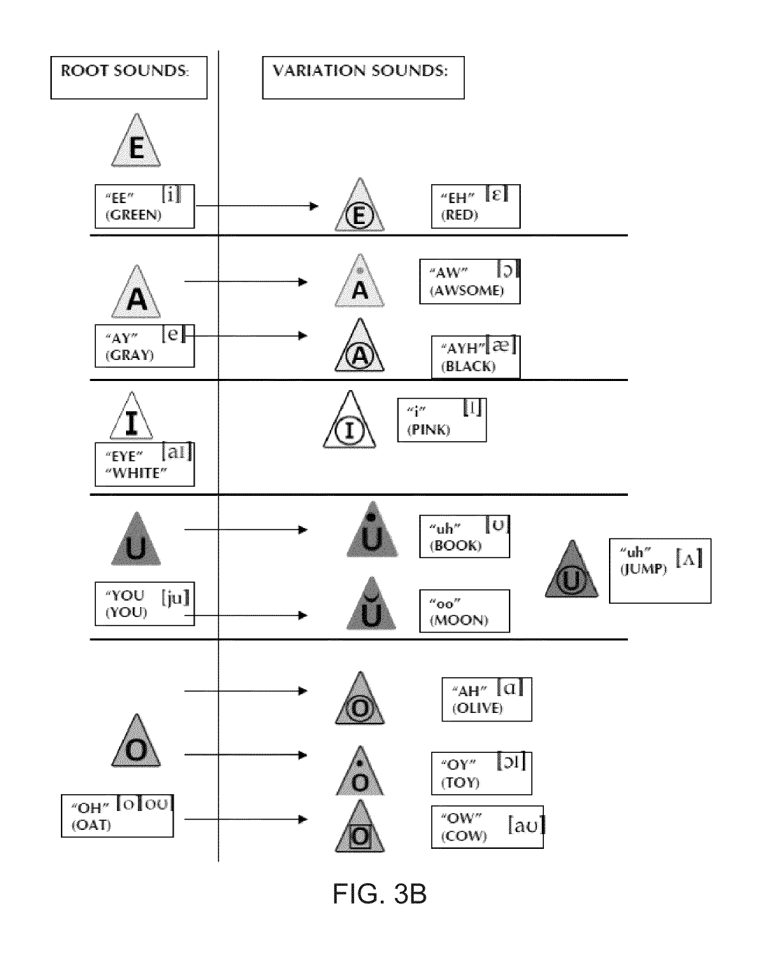

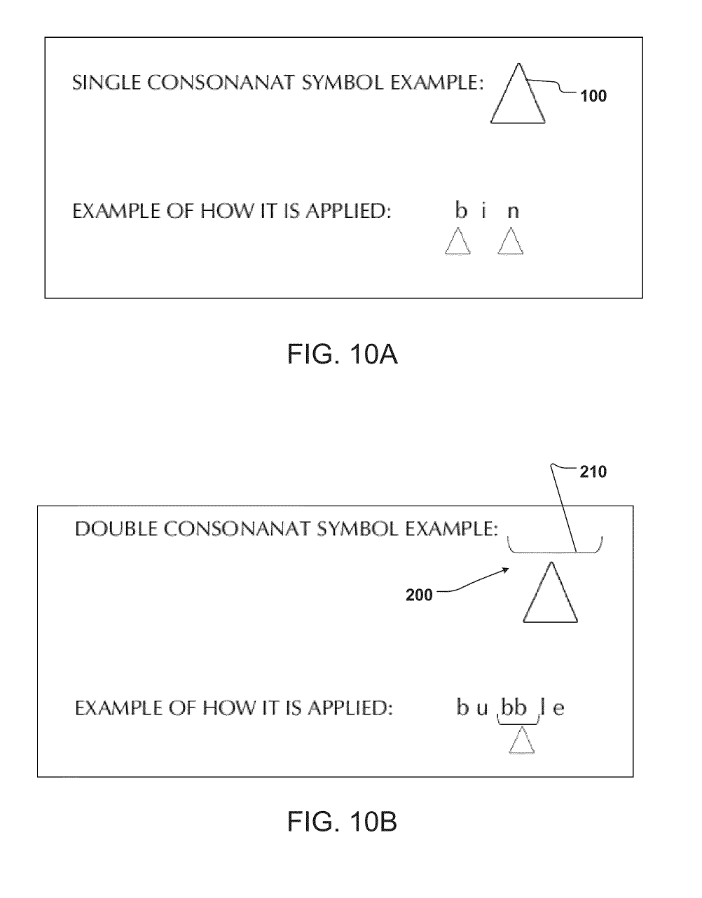

FIG. 3A shows an example of a visual symbol 10 according to the principles of the instant disclosure. As seen in FIG. 3A, the visual symbol 10 may comprise a shape 20, a character 30, and a fill 40. The visual symbol 10 may further include a grouper 210 (e.g., shown in FIG. 10B). The grouper 210 may be separate from the shape 20, or integrally formed with the shape 20. The shape 20 may include, for example, a triangle, a square, a circle, a pentagon, a hexagon, an octagon, a star, or the like. The boundary of the shape 20 may include a color, a shading, a texture, or the like. The character 30 may include, e.g., an IPA symbol, an image, a letter, or the like. The image may include, e.g., an image of a cherry, a plum, an apple, a car, a truck, or the like. The fill 40 may include a color, a shading, a texture, or the like, which may be substantially the same as, or different from the color, shading, texture, or the like, of the boundary of the shape 20.

The fill 40 may include a color that, when spoken, has a similar sound to the word(s) with which the visual symbol 10 may be associated. For instance, reaming to FIG. 3A, a visual symbol 11 may comprise a green colored fill 40 and a green boundary for the triangular shape 20 to emphasize the “EE” sound in e.g., the words “green,” “sea,” “weird,” “people,” “chief,” “key,” “machine,” “me,” and “ski.” The words may include, e.g., two colors, one of which is substantially the same as the boundary of the shape 20. In this example, a reader, upon viewing the visual symbol 11, may think of the color “green” and the sound “EE.” The letters “ee” in the word “green” may be colored green, so as to identify the particular letters in the word that have a sound associated with the character 30 and, optionally, the sound of the vowel in the spoken word for the color (e.g., green) that is used for the boundary of the shape 20. The grouper 210 (shown in FIG. 10B) may include, e.g., a bracket, a parenthetical, a line, a triangle, or any other mark(ings) that may suggest the grouping of two or more letters. The grouper 210 may be integrally formed with the shape 20, or provided separately from the shape 20.

As seen in FIG. 3A, a visual symbol 12 may include a green color in the fill 40, an indigo colored boundary of the shape 20, and an IPA symbol Ė for the character 30. In this example, the letters “i,” “y,” and “ui” may be colored indigo in the words “igloo,” “myth,” and “build,” respectively to match the indigo colored boundary of the shape 20.

In FIG. 3A, the visual symbols 13-17 may include a fill 40 that includes the colors gray (13), olive (14), purple (15), blue (16), and orange (17) respectively. As seen in the figure, various examples of words may be associated with the visual symbols 13-17.

FIG. 3B shows a plurality of examples of associations between root vowel sounds and variations of vowel sounds that may be represented by the visual symbols 10, according to the principles of the disclosure.

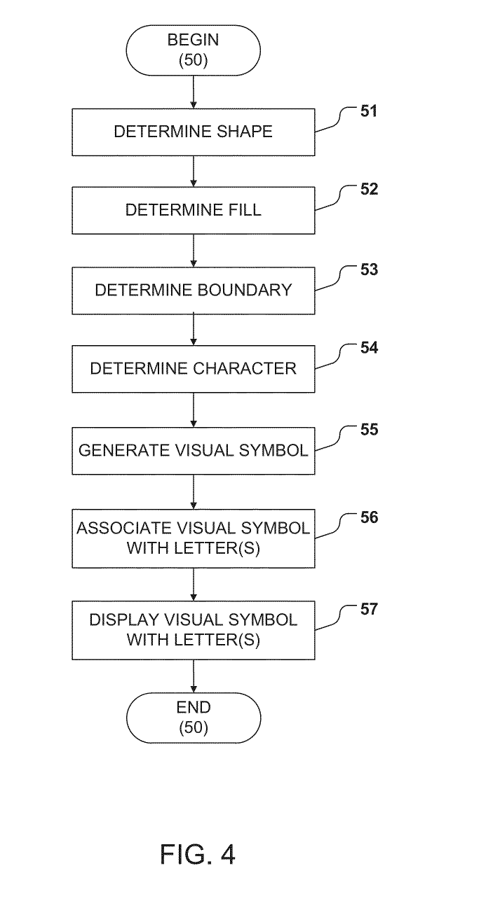

FIG. 4 shows an example of a visual symbol generation process 50, according to principles of the disclosure. Referring to the example of the visual symbol 10 (shown in FIG. 3), the process 50 may be carried out to generate the particular visual symbol 10 for a particular word(s). After (before, or at substantially the same time) a word or a set of words have been identified, a shape 20 (e.g., a triangle) may be determined or selected from a plurality of shapes (e.g., a triangle, a square, a circle, a star, a pentagon, a pyramid, a sphere, a cylinder, and the like) (Step 51). A grouper 210 (shown in FIG. 10B) may also be determined or selected if it is determined that two or more letters are to be represented by the visual symbol 10. A fill 40 (e.g., green) may be determined or selected from a plurality of colors (e.g., green, red, blue, orange, and the like) in the visible light spectrum (Step 52). A boundary (e.g., a color, a texture, a pattern, a width, or the like) of the shape 20 may be determined or selected from a plurality of boundaries (e.g., colors, textures, patterns, widths, and the like) (Step 53). A character 30 (e.g., Ė) may be determined or selected from a plurality of characters (e.g., the IPA symbols, images, letters, or the like) (Step 54).

After the shape 20 (Step 51), the boundary of the shape 20 (Step 53), the character 30 (Step 54), and/or the fill 40 (Step 52) have been determined or selected, which may have been determined or selected based on, e.g., a particular word(s) that is to be learned (or taught), the visual symbol 10 may be generated (Step 55). The visual symbol 10 may be associated with one or more letters in a particular word(s) that, e.g., is to be taught (or learned) (Step 56). The visual symbol 10 may be manifested in proper association with the letters in the particular word(s) (Step 57). For example, the visual symbol 10 may be manifested by displaying, printing, or other rise reproducing a visual symbol 10 below, above, adjacent to, or otherwise proximate to the letter(s) in the weird to make it evident to the reader that the visual symbol 10 is associated with the letter(s) on a teach medium, such as, for example, a display, a sign, a blackboard, a dry-erase board, a sheet or piece of paper, a transparency, a film, an analog recording medium, a digital recording medium, a computer readable mediums, a card, a book, a pad, and the like.

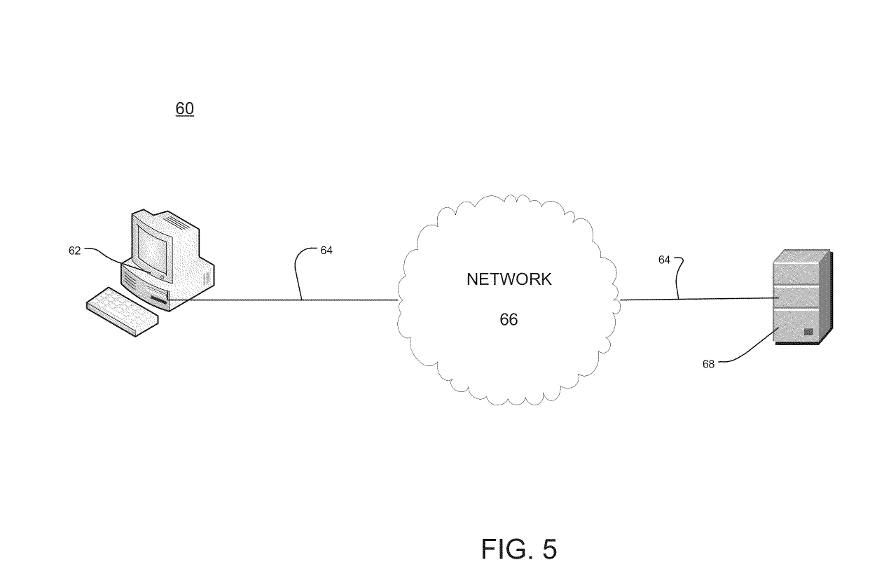

FIG. 5 shows an example of a system 60 that is constructed according to the principles of the disclosure. The system 60 may comprise a computer 62, a network 66, and a server (or computer) 68, each of which may communicate via a communication link 64. Alternatively, the system 60 may comprise only the computer 62 or only the server (or computer) 68. The system 60 may comprise a printer (not shown) which may reproduce, for example, a card, a page, a three-dimensional object, or the like, which may comprise a word and one or more associated visual symbols 10 to teach (or learn) to read the particular word. The system 60 may further comprise a database (not shown), which may be located locally in (or near) the computer 62 and/or server 68, or located remotely and connected to the computer 62 and/or server 68 directly through a communication link, or indirectly through a communication link and the network 66.

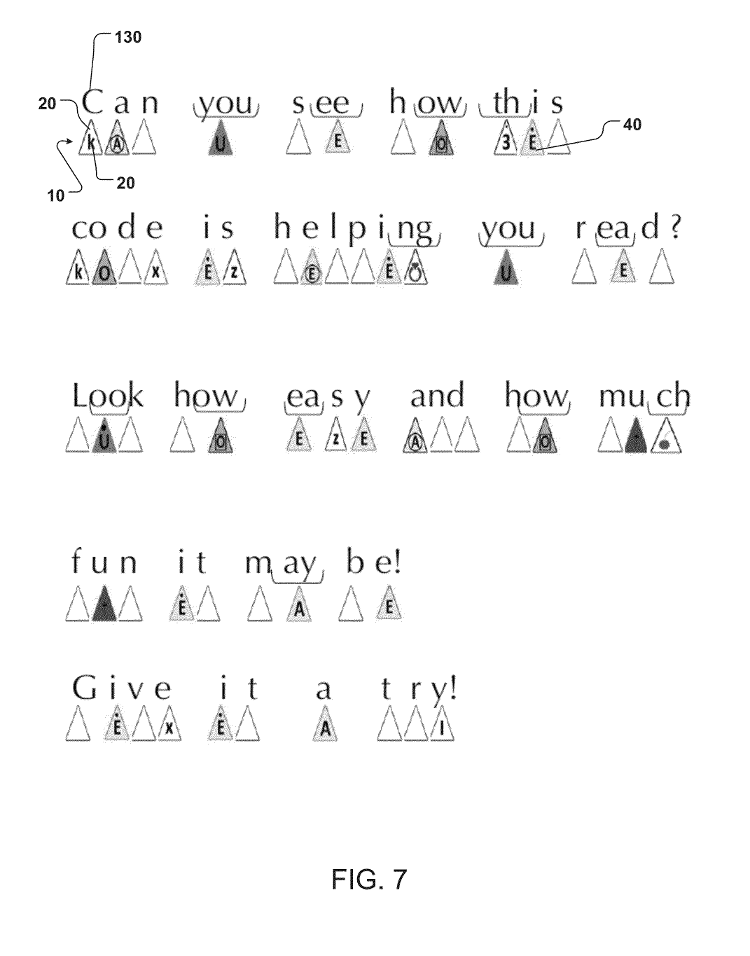

The database may include a library of words for a particular language(s), which may include words commonly taught in primary, secondary, or schools of higher learning. The database may further include a library of visual symbols 10. The database may also include files (or records) containing one or more shapes that may be used in the shape 20, one or more characters that may be used in the character 30, one or more colors, patterns, textures, etc., that may be used in the fill 40, and one or more marking that may be used in the grouper 210, any one or more of which may be included in each visual symbol 10 to represent a letter(s) in a word 130 (shown in FIG. 7). The words in the library may be mapped to associated visual symbols 10, so that each word may be retrieved from the database along with the associated visual symbols 10.

The system 60 comprises a computer readable medium that includes a computer program, which when executed on the computer 62 and/or server 68, causes the process 50 (shown in FIG. 4) to be carried out. The computer readable medium (not shown) may include a code section or code segment for each of the Steps 51 to 57 in the process 50. The system 60 may

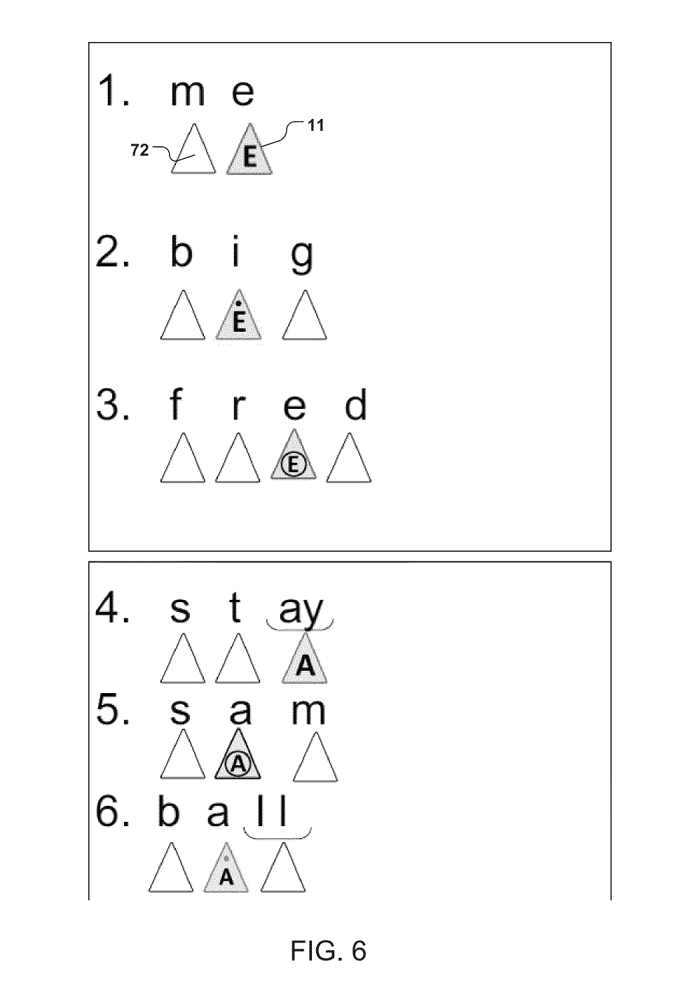

FIG. 6 shows six examples of words (or names) (e.g., “me,” “big,” “fred,” “stay,” “sam,” and “ball”) for which visual symbols 10 may be generated and displayed along with the words (or names). As seen in the first example (example “1”), the word “me” may be displayed with the visual symbols 72, 11 aligned under the letters “m” and “e,” respectively. As discussed above, with reference to FIG. 3A, the visual symbol 11 may include a triangular shape for the shape 20, an IPA symbol “E” for the character 30, a green color for the fill 40, and a green color for the boundary of the shape 20. The visual symbol 72 may have a triangular shape for the shape 20, but may exclude a character 30 and/or a fill 40. The absence of the character 30 may represent, e.g., that the associated letter has the common sound that is attributed to the letter, such as, e.g., the letter “n” in the word “can” in FIG. 7.

Examples 2 through 6 in FIG. 6 also include visual symbols 10 that are generated in accordance with the principles of the instant disclosure. The visual symbols 10 in examples 2-6 may include shapes (e.g., triangles) 20, boundaries of the shapes 20 that include a color (e.g., red in example 3) that are matched to the sounds of the vowels in the particular words (e.g., “fred” in example 3), characters 30 (e.g., IPA symbol Ė in example 2), and fills 40 (e.g., green in example 3). In the particular examples 2-6, the visual symbols 10 may include IPA characters 40 that represent the particular sounds associated with the letters “i,” “e,” “ay,” “a,” and “a” in the words “big,” “fred,” “stay,” “sam,” and “ball,” respectively.

The examples 1-6 in FIG. 6 may be generated and displayed, e.g., by the computer 62 shown in FIG. 5, or reproduced, e.g., by a printer (not shown) on a card, a paper, or any other object, which may be substantially planar, or non-planar (such as, e.g., a ball, a cube, a cylinder, or any other three-dimensional shape).

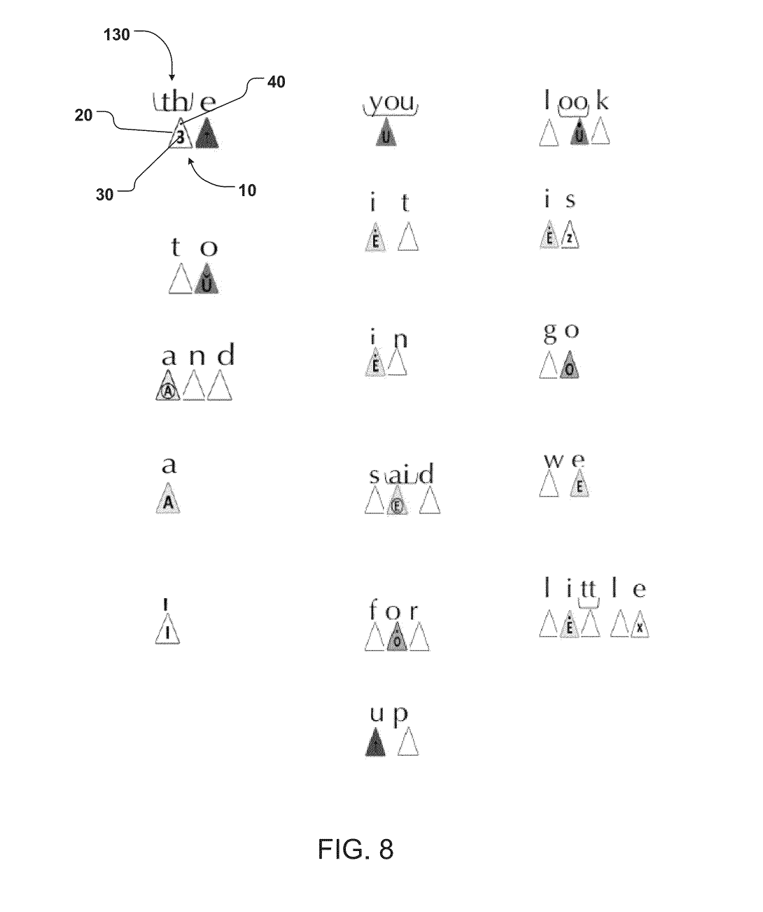

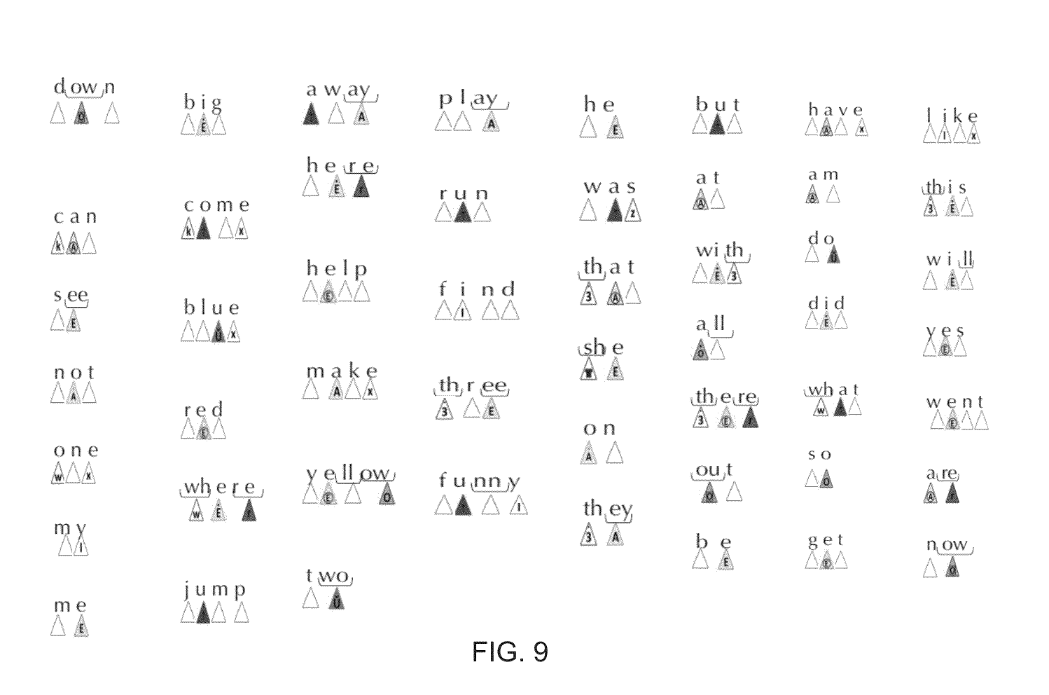

FIGS. 7-9 show various examples in which English-language letters and words may be represented (or coded) using the visual symbols 10 according to the principles of the disclosure. The disclosure facilitates a new approach to the task of learning (or teaching) to read.

Referring to FIG. 7, languages (e.g., the English language) comprise two basic parts: a variety of letters or characters (hereinafter letters) 130 arranged as narrative text that a person sees when reading the language and the actual sound that a person hears when the written language is spoken or pronounced. Each written letter 130, or group of letters 150, may correspond to a single speech sound so that an emerging reader could pronounce the letter 130 correctly whenever the letter(s) 130 appear in a word, regardless of the word in which the letter(s) 130 appear. Some languages, however, do not have a one-to-one mapping or correspondence between the letters 130 and speech sounds. English is an example of such a language. The instant disclosure solves this problem by providing unique visual symbols 10 that represent (or map or code) each letter 130 within a word to a speech sound (or non-sound) (i.e., a predetermined speech sound).

As seen in FIG. 7, the visual symbol 10 comprises a unique combination of features that may include, but are not limited to, the shape 20, the character 30, which may be provided inside or overlaid on the shape 20, wherein the character 30 is associated with a main sound (or non-sound) heard when one or more letters 130 within a word are pronounced (i.e., a predetermined speech sound). Each visual symbol 10 may also include the fill 40, which may include, e.g., a color, pattern, texture, or the like, that fills or outlines the shape 20. The fill 40 (and/or boundary of the shape 20) may be associated with a main sound (or non-sound) that is heard when one or more letters 130 within a word are pronounced (i.e., a predetermined speech sound).

Each visual symbol 10 may be uniquely tailored to represent the main sound (or non-sound) of a letters(s) 130 in a language such that the system of visual symbols 10 may provide for a one-to-one representation (or mapping) between each visual symbol 10 and each predetermined speech sound of a particular language.

To represent a letter(s) 130 within a word, the visual symbol 10 may be positioned near the letter(s) 130 within the word such that it is apparent that the visual symbol 10 corresponds to, or is associated with, the letter 130. The visual symbol 10 may be placed in any position near the letter 130 that it represents (e.g., above, diagonally to, to one side of, around, below, or near the letter 130 or group of letters 130), but is placed below the letter 130 in the examples provided in the disclosure. Such a placement may facilitate a style of reading which may direct a user to first look at the visual symbol 10 to determine what type of sound (i.e., the predetermined speech sound) the letter 130 makes and then to look at the actual letter 130 itself. Each visual symbol 10 in the system of the present disclosure may comprise a shape 20. All of the visual symbols 10 in the system may comprise the same shape 20 or the system may comprise visual symbols 10 having different shapes 20.

As noted earlier, any geometrical shape 20 (e.g., a star, an arrow, a square, a circle, a rectangle, a diamond, a polygon, a pentagon, or the like) may be used in the visual symbols 10. In the examples provided herein, a triangular shape 20 is employed since at least one tip of the triangle points to the letter 130 that is represented by the visual symbol 10, thereby guiding the reader's eye from the visual symbol 10 to the particular letter 130 that is represented by the visual symbol 10.

As also noted earlier, the visual symbols 10 may comprise the character 30, which may be provided inside of, or overlaid on the shape 20, wherein the character 30 is associated with a main sound (or non-sound) heard when one or more letters 130 within a word is pronounced (i.e., a predetermined speech sound). The character 30 may be designed to cue a reader to the main sound a letter 130 makes when it is pronounced within a word of a particular language (i.e., a predetermined speech sound).

For instance, as seen in FIG. 7, the character 30 may comprise IPA symbols that represent the particular sounds for the associated letters 130 in the words shown in the figure, including, e.g., “can,” “you,” “see,” “how,” “this,” etc. However, the characters 30 are in no way limited to IPA symbols, but may, instead (or additionally) include other symbols, objects, images, or the like.

For example, a character 30 may comprise a picture of a cherry associated with the combination of letters “ch” 130 to indicate that the combination of letters 130 have a “ch” sound that would be pronounced when speaking the word cherry. While the current disclosure provides an example of an image of a cherry being placed inside of a symbol, one of ordinary skill in the art would readily understand that the present disclosure need not be so limited. The characters 30 of the present disclosure may comprise any image which may cue a reader to pronounce a particular sound for a given letter 130 (i.e., a predetermined speech sound) in a given word (e.g., an image of a shirt may indicate the “sh” sound, an image of a 3 may indicate the “th” sound, and an image of a ring may indicate the “ng” sound, etc.).

The fill 40 may comprise a color, a pattern, a texture, an image, or the like, or any combination of the foregoing. The color may be used to fill the shape 20, to outline the shape 20, or to fill and outline the shape 20. For example, the entire inside of a shape 20 may be filled with a single color, while the shape 20 may be outlined with the same, or a different, color. Alternatively, the inside of the shape 20 may not be filled with a color but may only be outlined with a color. As such, the visual symbols 10 of the instant disclosure may utilize any color, pattern, texture, image, or the like, in any manner that may facilitate the representation (or mapping) of a letter 130 to a predetermined speech sound.

The placement of the visual symbols 10 described herein facilitates a novel reading experience. Traditionally, many languages (including English) are read by scanning displayed text letters 130 from left to right. The text may be written to be read from right to left, from top to bottom, or bottom to top. The present disclosure enables a person to read both up and down and then left to right. When reading up and down the visual symbol 10 indicates to the user that a particular sound (i.e., a predetermined speech sound) should be made when pronouncing letter 130 in a given word. After reading the visual symbols 10, a reader can scan mapped (or coded) text from left to right to determine the next sound that should be pronounced and repeat the process until the words of an entire sentence or paragraph have been read.

When the visual symbols 10 are placed below the written text (i.e., below the letter 130), the visual symbols 10 provide a path for a reader to place their finger while reading. This provides for a kinesthetic reading experience that helps to actively engage a person with the written text in an interactive manner. This experience helps an emerging reader slow down, and to focus, on individual sounds in a word, and avoid getting lost and confused in a large, cluttered, chunk of letters 130. As a result, the system operates to unclutter, or decode, large words, making the sounds of the representative letters 130 easily identifiable, and thereby facilitates a person's ability to efficiently learn how to read.

An exemplary system designed for the English language may include one or more groups of visual symbols 10, wherein each visual symbol 10 of the one or more groups of visual symbols 10 comprises a symbol associated with a predetermined speech sound selected from consonant sounds, silent sounds, vowel sounds, and/or division markups, or the like.

FIGS. 10A and 10B show a pair of examples wherein visual symbols 100 and 200 have been generated for the words “bin” and “bubble,” respectively. As seen, the visual symbol 100 is determined (or selected) for each consonant (e.g., “b” and “n”) in the word “bin”; and the visual symbol 200 is determined (or selected) for the double consonant “bb” in the word “bubble.” As seen in FIG. 10B, where the visual symbol 200 represents two or more letters, the visual symbol 200 may include a grouper 210. The grouper 210 may have any shape, color, pattern, texture, or the like. The group 210 is configured to identify the particular letter or letters represented by the visual symbol 200.

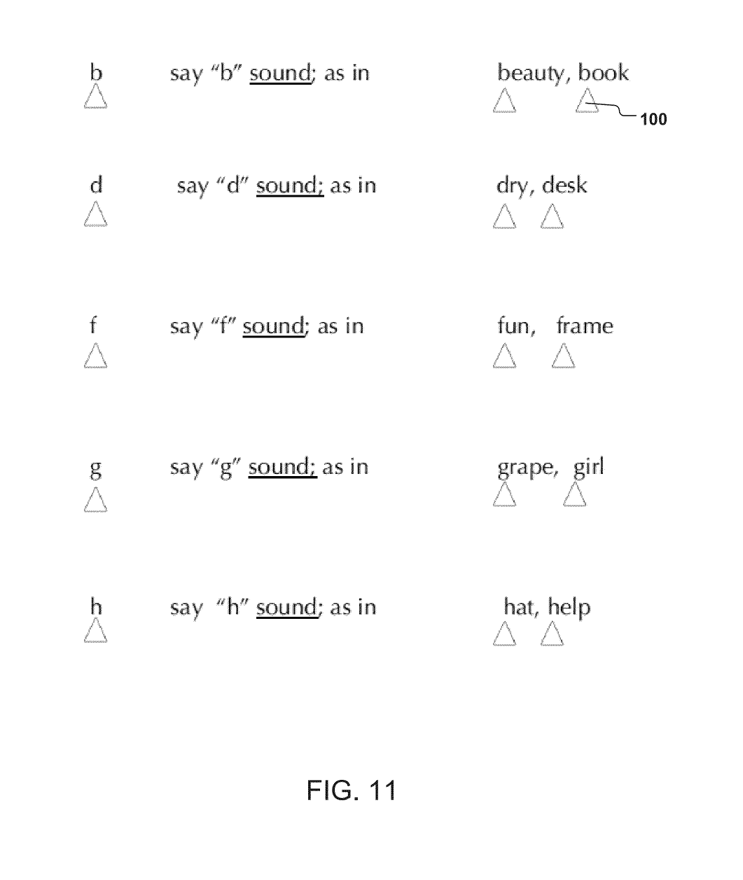

FIG. 11 shows an example of teaching (or learning) to read (and annunciate) the consonants “b,” “d,” “f,” “g,” and “h,” as well as the words “beauty,” “book,” “dry,” “desk,” “fun,” “frame,” “grape,” “girl,” “hat,” and “help.” As seen, the visual symbol 100 is properly positioned with respect to the associated letter in the word, to guide the reader to the particular letter that makes the sound represented by the visual symbol 100. In this example, the visual symbol 100 does not include a character 30 or a fill 40.

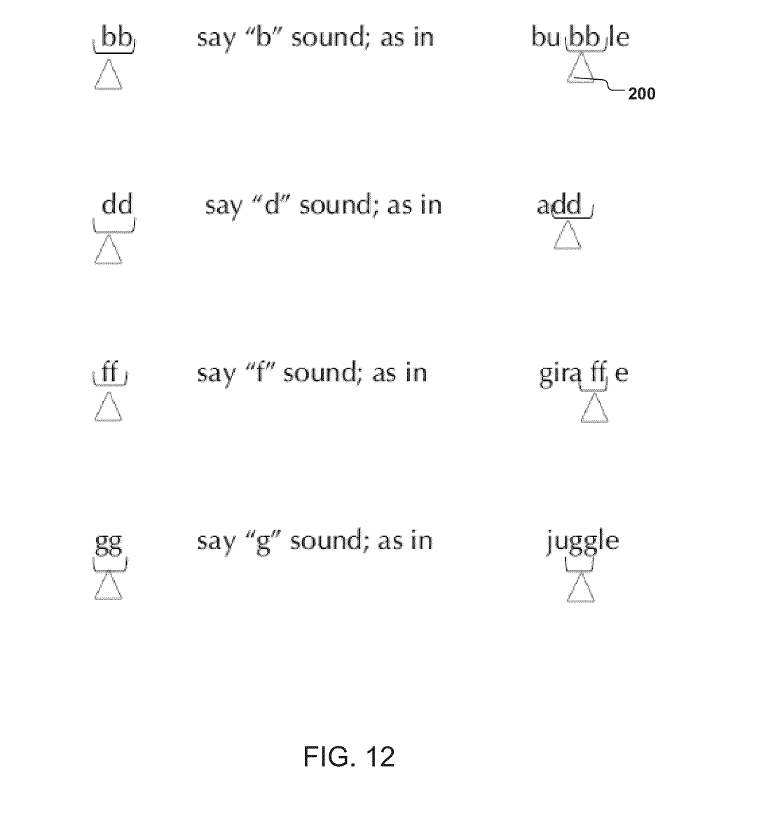

FIG. 12 shows an example of teaching (or learning) to read (and annunciate) the double consonants “bb,” “dd,” “ff,” and as well as the words “bubble,” “add,” “giraffe,” and “juggle.” As seen, the visual symbol 200 is properly positioned with respect to the represented letters (double consonant) in the word, to guide the reader to the particular letters that make the sound represented by the visual symbol 200. In this example, the visual symbol 100 does not include a character 30 or a fill 40.

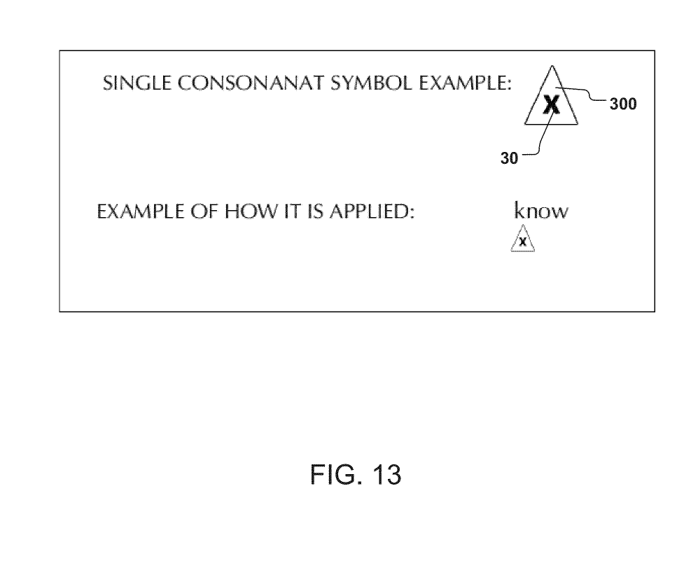

FIG. 13 shows an example of show a visual symbol 300 that may be generated for a single consonant (e.g., “k”) where the consonant may be, e.g., silent in the spoken word (e.g., “know”). In this example, the character 30 may include the IPA symbol “x” to represent the sound made by the letter “k” in the word “know.”

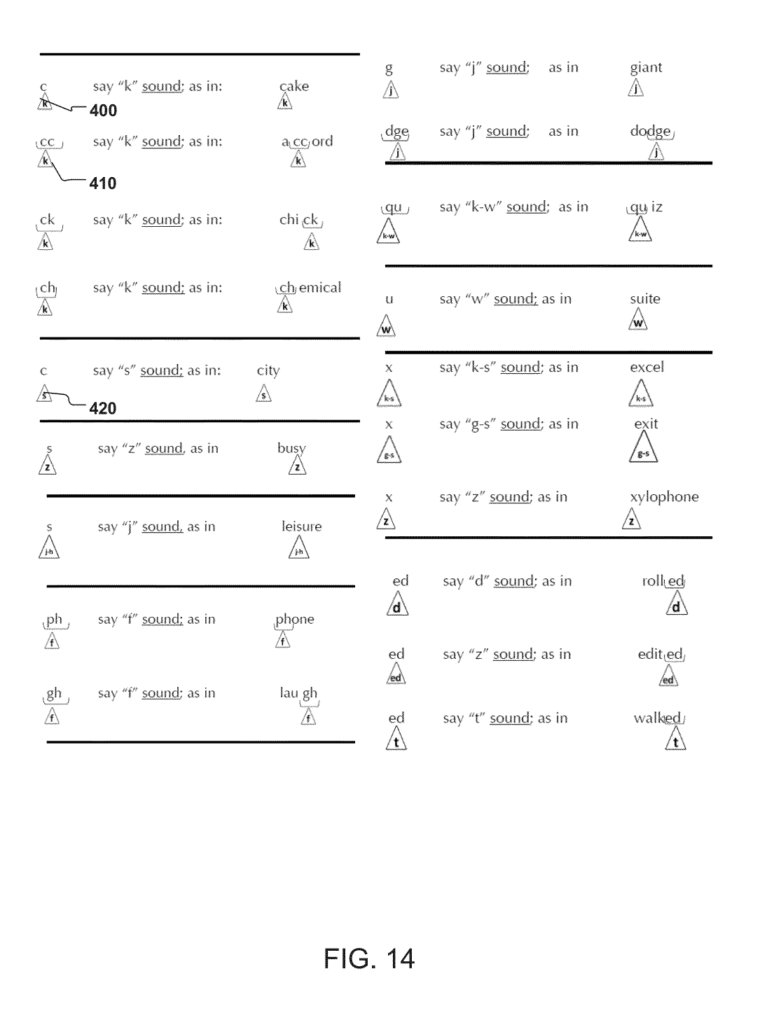

FIG. 14 shows a plurality of examples of visual symbols 400, 410, 420 that may be generated to represent the consonants “k” and “s” as they are used in the words, e.g., “cake,” “accord,” “chick,” “chemical,” and “city.” Additionally, the visual symbol may comprise multiple sound consonant grapheme symbols that may be used to represent consonants having multiple sounds to an isolated consonant sound, such as, a predetermined speech sound. For instance, the letter “c” can make both the /k/ and /s/ sounds; the letter “s” can make both the /s/ and /z/ sounds; and the like,

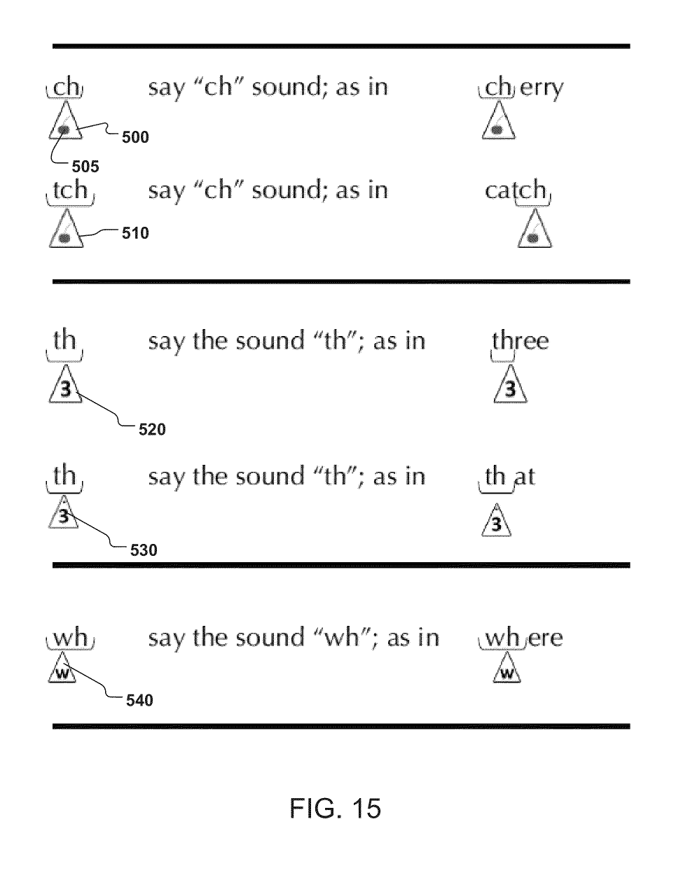

FIG. 15 shows a plurality of examples of visual symbols 500, 520, 530, 540 that may be generated to represent the letters “ch,” “th,” “th,” and “wh” as they are used in the words “cherry,” “three,” “that,” and “where,” respectively. As seen, the character 505 may include an image of a cherry, or the IPA symbols that represented the sounds made by the letters.

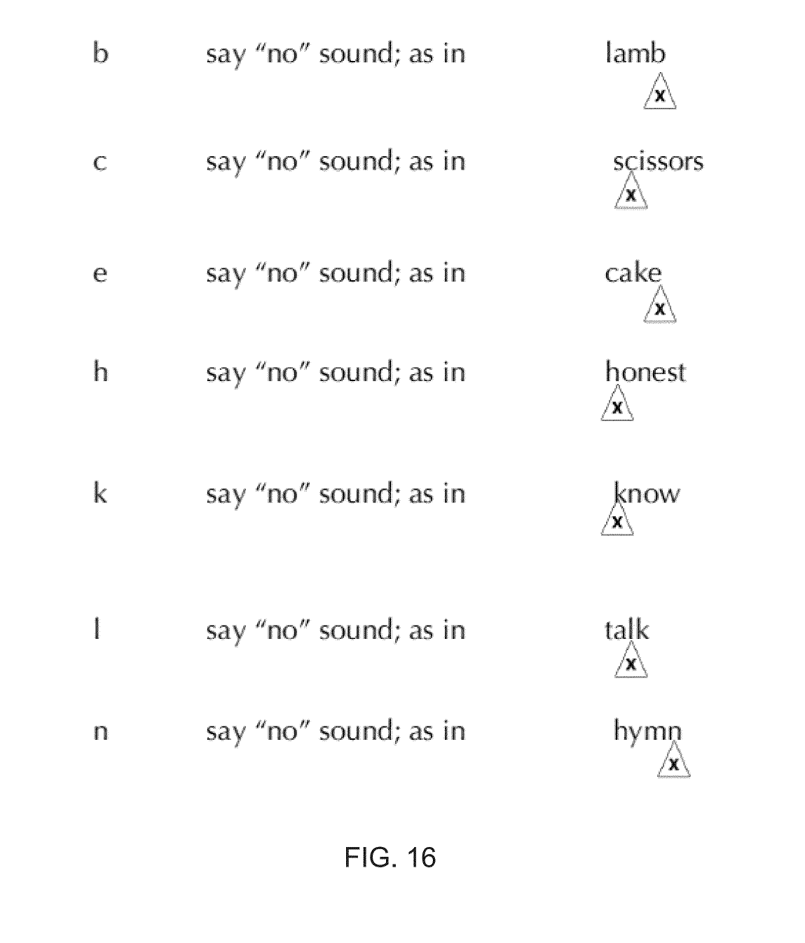

FIG. 16 shows a plurality of examples of implementations of the visual symbol 300 (shown in FIG. 13), to represent letters in words where the letters are silent (or not sounded) when spoken. As seen, the letters “b,” “c,” “e,” “11,” “k,” “l,” and “n,” are silent in the words “lamb,” “scissors,” “cake,” “honest,” “know,” “talk,” and “hymn.” The visual symbols 300 identify the particular letters that are silent in the words.

As seen in the figures, the visual symbols 10 may represent consonant sounds. Consonants are non-vowel letters 130 that that are associated with phonemes, or speech sounds, that are made by partially or completely blocking the vocal air stream. Visual symbols 10 for consonants may be derived from many different sources including, but not limited to, the International Phonetic Alphabet (I.P.A.) consonant symbols and a multitude of spelling variations used to represent consonant sounds. By utilizing such sources, the visual symbols 10 may be divided into at least four consonant grapheme, or letter 130, groups: single consonant grapheme visual symbols, double consonant grapheme visual symbols, multiple sound consonant grapheme visual symbols, and consonant digraph grapheme visual symbols.

The system of the instant disclosure may comprise single consonant grapheme visual symbols 10 that are used to represent a single consonant letter 130 (e.g., H makes an “h” sound, K makes a “k” sound, etc,) to an isolated consonant sound. This representation of a single consonant letter 130 may be achieved by placing a visual symbol 10 underneath, beside, above, or near a single consonant grapheme, or letter 130. When a reader encounters the visual symbol 10, the symbol cues the reader to pronounce the isolated speech sound (i.e., a predetermined speech sound) of the letter 130 associated with the visual symbol 10, thereby facilitating a person's ability to efficiently learn how to read.

Additionally, the system may comprise double consonant grapheme visual symbols that are used represent double consonant letters 130 (e.g., tall, nibble, fill, well, shoppe, matt, or the like) to an isolated consonant sound. This representation may be achieved by placing a visual symbol 10 underneath, beside, above, or near a particular double consonant grapheme. When a reader encounters the visual symbol 10, the symbol has the effect of cuing the reader to pronounce the isolated speech sound (i.e., a predetermined speech sound) of the letter 130, or combination of letters 130, associated with the visual symbol 10, thereby facilitating a person's ability to efficiently learn how to read.

When visual symbols 10 are utilized to represent double consonant letters 130, additional features may be utilized to indicate which letters 130 the visual symbols 10 are associated with. For instance, the visual symbol may include a grouper 210 (shown in FIG. 10B) may be used, which may include, for example, a bracket, a parenthetical, or the like, that represent the grouping or conjunction of two or more letters 130. This grouper 210 indicates to a reader that the group of letters 130 only makes a single sound (i.e., a predetermined speech sound). The reader can therefore quickly and confidently read a word without pondering over the correct pronunciation presented by combinations of letters 130.

Additionally, the visual symbol may comprise multiple sound consonant grapheme symbols that are used to represent consonants having multiple sounds (e.g., the letter “c” can make both the /k/ and /s/ sound, the letter “s” can make both the /s/ and /z/ sound, etc.) to an isolated consonant sound (i.e., a predetermined speech sound). This representation may be achieved by placing a visual symbol underneath, beside, above, diagonally to, or near a particular consonant grapheme having multiple sounds. When a reader encounters the visual symbol, the symbol has the effect of cuing the reader to pronounce the isolated speech sound (i.e., the predetermined speech sound) that is represented by the symbol, and that is directly associated with the letter(s) 130, thereby facilitating a person's ability to efficiently learn how to read.

The system discussed herein may also comprise visual symbols for consonant digraphs that are used to map combinations of two or more consonants (e.g., “p” and “h” combine to form “ph” making an “f” sound, “g” and “h” combine to form “gh” making an “f” sound, “c” and “h” combine together to form a “ch” making the “ch” sound, etc.) to an isolated sound. This representation may be made by placing a visual symbol underneath, beside, above, diagonally to, or near a particular consonant grapheme comprised of multiple letters 130 making a single sound (i.e., a predetermined speech sound). When a reader encounters this symbol, the symbol has the effect of cuing the reader to pronounce the isolated speech sound that is represented by the letters 130, directly associated with the visual symbol, thereby facilitating a person's ability to efficiently learn how to read.

The disclosed system may also comprise visual symbols to represent silent sounds (or non-sounds) (i.e., predetermined speech sounds). Silent sounds occur in a language when a word contains a letter 130, or combination of letters 130, that do not correspond to any sound in the word's pronunciation (e.g., the “b” in lamb, the “c” in scissors, the “e” in cake, etc.). Silent sounds resulting from silent letters 130 can create problems for a person learning o read because the person may not know that the letter 130 should be silent. A person, when attempting to read, may try to pronounce the letter 130 as the letter 130 is used in other words. Doing so could result in the word scissors being erroneously pronounced “skissors” as opposed to “sissors”.

FIGS. 13 and 16 depict examples where visual symbols may be utilized to represent letters 130 which are silent (i.e., should not be pronounced) in various English words. As seen in FIGS. 13 and 16, the letters 130 which should be mapped to a silent sound are associated with a visual symbol that indicates that the letter 130 should not be pronounced. While the current disclosure highlights an example of an “x” being used for the character 30 and placed inside of the visual symbol, one of ordinary skill in the art would readily understand that the present disclosure need not be so limited, For example, the symbols of the present disclosure may comprise any image or object which would indicated to the reader that a particular letter 130, or combination of letters 130, should be silent.

The system of the instant disclosure may further comprise visual symbols to represent vowel sounds. For instance, FIGS. 7-9 provide a plurality of examples where visual symbols that may be applied to main sounds of vowels (i.e., predetermined speech sounds) as they appear in various words of the English language. Vowels comprise phonemes, or speech sounds, that are generated when the vocal air stream is not blocked. In the English language, vowels comprise the letters A, E, I, O, and U. These five vowels, however, represent approximately sixteen different sounds produced by a wide range of spelling patterns. Visual symbols for vowels may be derived from one of many different sources including, but not limited to a phonetic alphabet (e.g., the International Phonetic Alphabet (I.P.A.)). Utilizing such sources, all vowel sounds may be divided into at least three vowel, grapheme, or letter 130, groups: vowel symbols, vowel dipthong symbols, and R-vowel symbols.

The visual symbols may comprise vowel symbols that are used to map a single vowel letter 130 (e.g., bin, bed, fat, up, three, etc.), vowel dipthongs which comprise a combination of two vowels (e.g., fear, there, mouth, stay, etc.), or R-controlled vowels comprising a vowel followed by an “r” (e.g., car, far, bird, card, sqirt, etc.) to an isolated vowel sound. The system may also comprise a visual symbol to represent the “schwa” sound. This mapping (or representation) may be achieved by placing a symbol underneath, beside, above, diagonally to, or near a vowel letter 130 or combination of letters 130. When a reader encounters this visual symbol, the symbol has the effect of cuing the reader to pronounce the isolated speech sound (i.e., a predetermined speech sound) of the letter 130, or combination of letters 130, that is directly associated with the visual symbol, thereby facilitating a person's ability to efficiently learn how to read.

The visual symbols may represent syllable division marks. A syllable is a unit of organization for a sequence of speech sounds which may be referred to as the building blocks of words. The syllable division marks of the present disclosure are represented by a line symbol that can be used to distinguish the sound breaks between syllables. Placement of such symbols may occur according to where sound breaks occur in multi-syllable words.

The system, method, and/or computer program disclosed herein will help turn the process of learning how to read into a positive, interactive experience. The visual symbols remind a person of the particular sound that needs to be pronounced for each letter 130 or group of letters 130. The disclosed system, therefore, transforms the process of learning how to read from a memorization process to a visual process. The disclosed system also allows the reader to step outside the boundaries of specific spelling and focus on the actual pronunciation of the language. As a result, a person learning to read can learn to read faster and more fluidly than conventional systems and methods provide.

The disclosed method and system may be implemented in a variety of different ways and in either low tech or high tech variations. For example, one or more of the visual symbols may be fixed in a tangible medium of expression so that they may be perceived, reproduced, or otherwise communicated with or without the aid of a machine or device. The term “tangible medium of expression” is intended to be broadly construed and may be any medium upon which the visual symbol(s) can be fixed. For example, the visual symbol(s) may be fixed on a blackboard, a dry erase board, a piece of paper, a transparency or film, analog or digital recording media (e.g., magnetic or optical recording media such as storage tapes or disks), or an internet website.

One or more of the visual symbols of the instantly disclosed system may also be communicated by using a central processing unit (i.e., a CPU) to execute instructions for mapping/coding letters 130 stored in a computer readable medium and display mapped/coded text on a computer screen, smart phone, iPod, iPad, smart board, or the like. Similarly, the visual symbols 10 could be employed by software to map/code letters 130 or could be accessed from the cloud, and be delivered across a network, such as the internet, in order to be displayed on a user's computer screen, smart phone, iPod, iPad, smart board, or the like.

The system discussed herein may teach a user to read by clearly mapping/coding a single visual symbol to a particular sound (i.e., a predetermined speech sound). Instead of a person memorizing a particular sound that applies to a letter 130, or group of letters 130, the person can determine the appropriate sound for a letter 130, or group of letters 130, dynamically while reading. This may enable an emerging reader to learn to read in an efficient and enjoyable manner.

### EXAMPLE

The following example, which includes eighteen (18) lessons, may be implemented according to the principles of the disclosure.

Lesson #1: Phonemic Sound Segmentation. Materials that may be provided for this lesson may include, e.g., an empty triangle symbol (Δ) card, a deck of consonant sound drill cards, an assessment sheet for Lesson #1, and a worksheet for Lesson #1. The empty triangle symbol card may be provided as a large size card for a plurality of students, and/or a small card for one-to-one training The deck of consonant sound drill cards may be provided as a large size deck for the plurality of students, and/or a small size deck for one-to-one training.

The Lesson may begin with an instructor (trainer) holding up the empty triangle symbol card, and pointing to the shape on the card and saying:
I am going to teach you the first symbol that you must know for this program. This shape that I am pointing to is known as the Empty Triangle Symbol. Every time that you see this Empty Triangle Symbol placed under a letter you will look just above the triangle tip and just say the sound that the letter makes. As you may notice, the triangle is like an arrow pointing up at a specific letter. In other words, the triangle is telling you to make a sound. I will show you several examples now.
   The instructor may then open up the deck of consonant sound drill cards and take out a first card from the deck, pointing a finger inside the empty triangle symbol under the letters so that the student can follow along. The instructor may say:
I am holding a deck of alphabet cards. Inside of this deck are all of the consonant sounds in the alphabet combined with the Empty Triangle Symbol that I just showed you. Here, the Empty Triangle Symbol is placed under letter. On this first card here, please notice that the Empty Triangle Symbol is placed under the letter “B”. Therefore, when you see this together, you will just say the “b-uh” sound. It is recommended that you can even place your finger inside of the Empty Triangle Symbol to help you focus on the exact sound that specific letter makes. In fact, you can even put your pencil tip or finger-tip inside of the triangle when you are sounding out each sound. This can help you and can be fun.
   The instructor may then take out a second card from the deck and say:
Here is another example. Here, the Empty Triangle Symbol is placed under the letter “D,” so you will just say the “d-uh” sound. Does everybody see how this is working? To review, we are just saying the sound that the letter makes when we see the Empty Triangle Symbol under a letter. This process is called “segmenting a sound” or “isolating a phonemic sound”.

For group practice, the instructor may take out the set of consonant sound cards and begin a consonant sound drill, which may allow the instructor to assess whether the student/class can pronounce and isolate the accurate sound that each consonant makes. The instructor may go through all the consonant letters in the alphabet combined with the Empty Triangle Symbol placed under the letters shown. The class (or student) may pronounce the single sound they hear and will go through the entire deck of consonant sound cards out loud. The instructor may say:
Now, let us all practice saying together the consonant sounds that we hear in the alphabet using the Empty Triangle Symbol. Remember that when I show you a card, you will just say the single sound that you hear when I hold up a letter from the alphabet. When you say the sound that the letter makes, you are expressing that you know how to “segment a sound”. We will do a couple examples together. If you have trouble with a sound, I'll help you.
   The class may go through the entire deck together, with the instructor's assistance.

For individual practice, each student may go through the entire deck of cards out loud individually to a listener. Each student may also complete a worksheet Lesson #1.

The instructor may listen and document the correct/incorrect answers that each student says using the assessment sheet provided.

Lesson #2: Silent Triangle Symbol. Materials that may be provided for this lesson may include, e.g., an silent triangle symbol (e.g., a Δ with an x inside the Δ) card, a deck of silent triangle symbol cards, an assessment sheet for Lesson #2, and a worksheet for Lesson #2. The card/deck may be provided as a large size card/deck for a plurality of students, and/or a small card/deck for one-to-one training.

Lesson #2 may begin with an instructor holding up the silent triangle symbol card, and pointing to the shape on the card and saying:
I am going to teach you our second new symbol that you must know for this program. This shape that I am pointing to is known as the Silent Triangle Symbol. Every time that you see this Silent Triangle Symbol placed under a letter (or under a group of many letters) you will look just above the triangle tip and DO NOT say any sound. This symbol is called the Silent Triangle Symbol because your voice will be silent whenever you see this symbol under a letter or letters. The big “X” reminds you DO NOT say this sound. It's like a “Don't do it!” reminder.
   The instructor may then show the silent triangle symbol deck of cards. The instructor may emphasize the silent nature of the sound by crossing her fingers over her mouth and making the shape of an X with her fingers, to show that we do not say anything when we see this symbol and the “X” is the same like the card. The instructor may then say:
We will look at some examples now. For instance, if the Silent Triangle Symbol is placed under the letter “B”; in a word then DO NOT say the “b-uh” sound. Just stay silent.
   The instructor may model three words out loud with a silent B and while the students show her when to be silent by crossing their fingers over their mouths when they get to the silent letter.

For group practice, the instructor may take out the deck of cards with examples of the silent triangle symbol and begin a practice drill where the class (or student) will practice not saying a single sound when they see the silent sound symbol used with the other silent letters in the English language, such as, e.g., B, C, E, H, K, L, N, P, S, T. U, W. The instructor may say:
Now, let us all practice saying together using the Silent Triangle Symbol. Remember that when I show you a card with the Silent Triangle Symbol, you will NOT say any sound when I point to a letter (or two letters). Since there are so many silent letters in English, this Silent Triangle Symbol will help you remember when to NOT say a sound. Sometimes the Silent Triangle Symbol will be found the beginning of the word, sometimes at the end of a word and sometimes you will see it under in the middle of a word! Let us practice some more.
   The class may go through the entire deck together, with the instructor's assistance.

For individual practice, each student may work on a practice work sheet for the skill.

The instructor may listen and document he correct/incorrect answers that each student says using the assessment sheet provided.

Lesson #3: Multiple Sound Symbols. Materials that may be provided for this lesson may include, e.g., a multiple sound symbols deck of cards, an assessment sheet for Lesson #3, and a worksheet for Lesson #3. The deck may be provided as a large size deck for a plurality of students, and/or a small deck for one-to-one training.

Lesson #3 may begin with an instructor saying:
Did you know that in English, there are some letters that make two different sounds? For example, lets look at the letter C. Sometimes the letter C says the “k-uh” sound and sometimes the letter C makes the “sss” sound. Also, sometimes the letter G makes the “g-uh” sound and sometimes it makes the “j-uh” sound. With the SURE program, we have created triangles that will show you which sounds you should pronounce in each word, so that you are not confused anymore!
   The instructor may then take out the Multiple Sound Symbols deck and point her finger inside the first symbol under the letter so the class can follow along. The instructor may say:
This Multiple Sound Symbol “K” [symbol] represents the “k-uh” sound. For instance, when you see it under a letter, like the letter C, then you will just say the “k-uh” sound.
This Multiple Sound Symbol “F” [symbol] represents the “f-uh” sound. For instance, when you see it under a letter combination, like the letters PH, then you will just say the “f-uh” sound.
   The instructor may model three words out loud with a multiple sound symbol and point out how the letters change sounds when the triangles are added below.

For group practice, the class (or student) may pronounce the sound associated with the letter(s). The class may go through the entire deck together.

For individual practice, each student may go through the deck of cards out loud individually with a listener. Each student may also work on a practice work sheet for the skill.

The instructor may listen and document the correct/incorrect answers that each student says using the assessment sheet provided.

Lesson #4: “Long E” Triangle Sound Symbol. Materials that may be provided for this lesson may include, e.g., a long E triangle symbol card, a deck of flash cards (coded and un-coded), an assessment sheet for Lesson #4, and a worksheet for Lesson #4. Coded cards may include one or more words and the corresponding symbol(s). The card/deck may be provided as a large size card/deck for a plurality of students, and/or a small card/deck for one-to-one training.

Lesson #4 may begin with an instructor saying:
So just like before, you know that whenever you see a Triangle shape under a letter or group of letters, you are going to say the sound or non-sound that you hear above the tip of the triangle point.
   The instructor may then take out the long E triangle symbol card and point her finger inside the symbol so the class can follow along. The instructor may say:
In this lesson, you will be learning a new symbol called the LONG E Triangle Symbol. As you can see, there is a large E inside of it. When you see this symbol, you will say this sound: “EEEEE”.
Did you notice that clue for the sound is very simple? Whenever you see a big letter E inside of the triangle, just say the sound EEE!
In other words, the sound that you will make is also the exact same name of the letter inside of the triangle; E!
in addition, the color inside of the triangle is green. That color can be another clue for you to use to remember the EEEE sound!
Now everybody let's look at this LONG E Triangle Symbol and say the sound together (EEEEEE).

For group practice, the class (or student) may pronounce the sound associated with the letter(s) when they see the symbol. The teacher may hand out a long F triangle symbol card to each student. The class may practice doing a worksheet as a group.

For individual practice, each student may individually say the sound associated with the letter(s) (and symbol) to a listener. Each student may also work on a practice work sheet for the skill.

The instructor may listen and document the correct/incorrect answers that each student says using the assessment sheet provided.

Lesson #5: “Long O” Sound Symbol. Materials that ay be provided for this lesson may include, e.g., a long O triangle symbol card, an assessment sheet for Lesson #5, and a worksheet for Lesson #5. The card may be provided as a large size card for a plurality of students, and/or a small card for one-to-one training.

The instructor may begin Lesson #5 by taking out the long O triangle symbol card and pointing a finger inside the symbol so the class can follow along. The instructor may say:
In this new lesson, every time you see this green LONG O Triangle Symbol with a large O inside of it, say this sound with me: OHHHHH”.
Did you notice that clue for the sound is very simple. Whenever you see a big letter O inside of the triangle, just say the sound OH!
In other words, the sound that you will make is also the exact same name of the letter inside of the triangle; O!
In addition, the color inside of the triangle is Orange. That color can be another clue for you to use to remember the OH sound!
Now everybody let's look at this LONG O Triangle Symbol and say the sound that we will say when we see this symbol all together. (OHHHH)
Now everybody let's look at this LONG E Triangle Symbol and say the sound together (EEEEEE).

For group and/or individual practice, the same steps as in Lessons #1, #2, or #3 may be carried out here, including individual practice, worksheet completion, and assessment.

Lessons #6 through #18 may be carried out similar to, for example, Lesson #5, for each of the following: long “A” sound (#6, e.g., [symbol] ); long “I” sound (#7, e.g., [symbol] ); “OO”/“YOU” sounds (#8, e.g., [symbol] ), “SH”/“TH”/“NG”/“CH” sounds (#9, e.g., [symbol] , [symbol] , [symbol] , [symbol] , respectively); short “A” sound (#10, e.g., [symbol] ); short “I” sound (#11, e.g., [symbol] ); short “O” sound (#12, e.g., [symbol] ); short “E” sound (#13, e.g., [symbol] ); short “U” sound (#14, e.g., [symbol] ); “OW” sound (#15, e.g., [symbol] ); “OI” sounds (#16, e.g., [symbol] ); “AWE” sounds (#17, e.g., [symbol] ); and “R” sounds (#18, e.g., [symbol] ).

A “computer,” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like.

A “server,” as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database,” as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database nay be configured to run the at least one application, often under heavy workloads, unattended, for extended periods of time with minimal human direction.

A “communication link,” as used in this disclosure, means a wired and/or wireless medium that conveys data or information between at least two points. The wired or wireless medium may include, for example, a metallic conductor link, a radio frequency (RF) communication link, an Infrared (IR) communication link, ate optical communication link, or the like, without limitation. The RF communication link may include, for example, WiFi, WiMAX, IEEE 802.11, DECT, 0G, 1G, 2G, 3G or 4G cellular standards, Bluetooth, and the like.

A “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, or the like, or any combination of the foregoing, any of which may be configured to communicate data via a wireless and/or a wired communication medium. These networks may run a variety of protocols not limited to TCP/IP, IRC or HTTP.

The terms “including,” “comprising,” and variations thereof, as used in this disclosure, mean “including, but not limited to,” unless expressly specified otherwise.

The terms “a,” “an,” and “the,” as used in this disclosure, means “one or more,” unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium,” as used in this disclosure, means any medium that participates in providing data (for example, instructions) which may be read by a computer, Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium may include a “Cloud,” which includes a distribution of files across multiple (e.g., thousands of) memory caches on multiple (e.g., thousands of) computers.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

While the disclosure has been described in terms of exemplary embodiments, those skilled in the art will recognize that the disclosure can be practiced with modifications hat fall within the spirit and scope of the appended claims. These examples given above are merely illustrative and are not meant to be an exhaustive list of all possible designs, embodiments, applications or modifications of the disclosure.

What is claimed is:

1. A method of natural language training, comprising:
identifying a word that is to be read by a reader, the word comprising a plurality of letters;
determining a visual symbol associated with at least one of the plurality of letters; and
manifesting the visual symbol in association with the at least one of the plurality of letters,
wherein the visual symbol is associated with a predetermined speech sound, and
wherein the visual symbol comprises:
a shape that includes a triangle;
a character that includes an IPA symbol; or
a fill that includes a color.

2. The method of claim 1, wherein the character is formed in the shape.

3. The method of claim 1, wherein the fill is provided in the shape.

4. The method of claim 1, wherein the shape comprises a boundary that includes a boundary color.

5. The method of claim 4, wherein the fill comprises a fill color that is substantially the same as the boundary color.

6. The method of claim 4, wherein the fill comprises a fill color that is different from the boundary color.

7. The method of claim 1, wherein the manifesting the visual symbol in association with the at least one of the plurality of letters comprises displaying the visual symbol proximate to the at least one of the plurality of letters on a display.

8. The method of claim 1, wherein the manifesting the visual symbol in association with the at least one of the plurality of letters comprises printing the visual symbol proximate to the at least one of the plurality of letters on a teach medium.

9. A method natural language training, comprising:
identifying a word that is to be read by a reader, the word comprising a plurality of letters;
determining a visual symbol associated with at least one of the plurality of letters; and
manifesting the visual symbol in association with the at least one of the plurality of letters.

10. The method of claim 9, wherein the visual symbol is associated with a predetermined speech sound.

11. The method of claim 9, wherein the visual symbol comprises at least one of a shape, a character, and a fill.

12. The method of claim 11, wherein the visual symbol further comprises a grouper that is associated with two or more of the plurality of letters.

13. The method of claim 10, wherein the predetermined speech sound is selected from a dipthong sound, a consonant sound, a double consonant grapheme sound, a double consonant sound, a multiple sound consonant grapheme, a silent sound, a vowel sound, and a syllable division markup.

14. The method of claim 13, wherein the visual symbol is associated with an isolated consonant sound.

15. The method of claim 10, wherein the visual symbol is associated with two or more of the plurality of letters, and wherein the visual symbol represents a combination of two or more consonants.

16. The method of claim 12, wherein the grouper comprises a bracket or a parenthetical to represent a combination of two or more consonants.

17. The method of claim 10, wherein the predetermined speech sound comprises a silent sound.

18. The method of claim 10, wherein the predetermined speech sound is derived from a phonetic alphabet or a phonetic vowel chart.

19. The method of claim 10, wherein the visual symbol is associated with two or more of the plurality of letters, and wherein the visual symbol represents a combination of two or more vowels.

20. A system for training a reader to read a natural language, the system comprising:
a computer that:
identifies a word that is to be read by a reader, the word comprising a plurality of letters;
determines a visual symbol associated with at least one of the plurality of letters; and
displays the visual symbol in association with the at least one of the plurality of letters.
